(19) United States
(12) Patent Application Publication
(10) Pub. No.: US 2019/0034603 A1
(43) Pub. Date: Jan. 31, 2019

(54) COMPUTER IMPLEMENTED METHOD

(71) Applicant: Mallory Dyer, Coolidge, AZ (US)

(72) Inventor: Mallory Dyer, Coolidge, AZ (US)

(21) Appl. No.: 16/150,449

(22) Filed: Oct. 3, 2018

Related U.S. Application Data
(62) Division of application No. 15/191,528, filed on Jun. 24, 2016.

(51) Int. Cl. G06F 21/31; H04W 4/021; H04W 12/08

(52) U.S. Cl. CPC G06F 21/31; H04W 4/021; H04W 12/08; G06F 2221/2105

(57) ABSTRACT

A computer implemented method wherein the computer implemented method enables its use on a user's smart device and runs on Android/IOS platforms and enables at least one user to use the computer implemented method on a smart device and also enables at least one mentor to use the same computer implemented method at the same time, wherein the use of this computer implemented method by the mentor enables the mentor to control the computer implemented method of the users through a lockdown mode to control the computer implemented method of the users and thus lock the smart devices of the users to restrain the users from opening any other application, close out of the computer implemented method, or receive any notifications during the use of the computer implemented method.

### CROSS-REFERENCE TO RELATED APPLICATION

The present application is related to and claims priority from prior provisional application Ser. No. 15/191,528, filed Jun. 24, 2016 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE INVENTION

The present invention generally relates to a computer implemented method designed to operate on a smart device and is also provided with a direct accessibility feature with an enabled lockdown code and capability.

### BACKGROUND OF THE INVENTION

An electronic calculator is a small, portable electronic device used to perform both basic operations of arithmetic and complex mathematical operations.

In addition to this, the calculator is an educational tool that allows students to reach higher levels of mathematical understanding, reasoning, number sense, and computer implemented methods. Four function, scientific and graphing calculators as well as calculators with computer symbolic algebra manipulation capabilities provide new pedagogical enhancement opportunities. They afford students learning tools that complement, but do not replace, mental and paper and pencil skills and they expand the student's ability to solve problems by providing multiple solution techniques.

However, the changes in our economy have greatly impacted students, many students do not have the funds to purchase a calculator wherein, almost every student that enrolls in college needs a graphing calculator for some or other course and the graphical calculators used by the students in their problem solving subjects are out of the reach of many people. Moreover calculators or the similar devices present in the market are only able to meet the needs of a calculator which is able to perform the scientific and arithmetic calculations and are not provided with any additional features. Although calculators are available in our smart devices, they are not enabled with a feature which makes them perfect for use for school and college examinations. Neither the smart phones provided with calculators or graphical calculators posses a lock down mode feature wherein the student is enabled only to use the applications provided by the calculator and not the use of any other smart phone feature.

The various smart devices provide a number of features wherein these features and applications provided in the smart devices are not useful at the time a student is studying. The features available in these smart devices lead to the diversion of the student's mental attention and distract them from their studies. The various applications installed on our smart devices are sometimes time killing and lead to a disturbance when a person is trying to concentrate on his/her work and the use of an application within his/her smart device that pertains to their studies.

Therefore, there remains a need to overcome the above mentioned problems and our invention resolves this entire problem.

### SUMMARY OF THE INVENTION

The main objective of the present invention is to overcome the limitations of the prior arts by providing a computer implemented method designed to operate on a users smart device and is also provided with a direct accessibility feature with enabled lockdown code and capability.

The present invention of a computer implemented method enables its use on the user's smart device and runs on the Android and iOS platforms but is not limited to these only. The present invention enables at least one user to use the computer implemented method on a smart device and also enables at least one mentor to use the same computer implemented method at the same time, wherein the use of this computer implemented method by the mentor enables the mentor to control the computer implemented method of the user through the lockdown mode. The lockdown mode used by the mentor enables him/her to control the computer implemented method of the user and thus lock the smart device of the user to restrain the user from opening any other application, close out of the computer implemented method, or receive any notification during the use of the computer implemented method. Therefore, converting the user's smart device solely to the computer implemented method, wherein during the lockdown mode the user cannot exit out of the computer implemented method, cannot make or receive calls, send texts, open other computer implemented methods, receive new notifications, access the internet, access social media sites, or take pictures, also the user's smart device does not make any noise during the lock down mode.

Moreover, the present invention of the computer implemented method is used by a teacher wherein, the teacher is enabled to create a group of students on the computer implemented method and then control the use of the computer implemented method for those groups of students. For this, the teacher is enabled to register on the computer implemented method, select the students using the computer implemented method and form a group of selected students on the computer implemented method. The teacher then assigns the group of students a name and a unique code which is generated by the computer implemented method. The students are registered in the group by two ways wherein, the teacher is either enabled to send the students the unique code to enter the lock down mode and have the student text/email it to a general account or the teacher is enabled to add students manually by entering their email/unique code that is linked with the student's account. Once a student is registered into an account, his/her name appears in black on the roster displayed on the computer implemented method of the teacher. The teacher then selects the unique ID which appears by the student's name in the roster (in case they have students with the same name). When the teacher wants to add the group of students into lockdown mode, the teacher first selects the group of students and customizes the computer implemented method. To customize the computer implemented method, the teacher first clicks the link which pulls up all computer implemented method functions. The teacher is enabled to “X” out any functions he/she does not want the student to use at that time or for a add date and time range. The teacher then instructs the students to open the computer implemented method on their smart device and select the “lockdown mode”. The students are prompted to login and enter their email/ID linked to the account. Once the student has logged in, his/her name now appears in green with a check mark next to it on his/her smart device with a green border on the screen. If a student tries to log out of the lock down mode his/her name go to red with an X by it and the border turns red. As the students are all logging in, the teacher enters the timer and the lockdown code that they have created. Once all students names are in green, the teacher selects “enter lockdown code” button. When the teacher does this a “start timer” button appears on the student's device. If the student tries to exit or open another application at this point, their name appears in red with an X, the border on his/her device turns red, and the website/app makes a noise to notify the teacher. If the teacher is controlling it by their own device, the teacher will receive a notification banner. The student is also not able to have access to the computer implemented method until he/she actuates “start timer.”

Also, the parent is enabled to create a login/ID for the user, wherein the user is enabled to login using the email/ID created by his/her parent and the user remains in the parent's account until the parent deletes the user from his/her account. Herein, the user name shows up in black on the parent's home page and the parent instructs the user to open the computer implemented method and select “Lockdown Mode” which then prompts the user to login using the account created by the parent. Once the user has done this, his/her name appears in green with a check mark next to it on the computer implemented method of the parent and the parent are then enabled to enter in a timer with a lockdown code. Once the parent hits “enter lockdown code” the user gets a “start timer” option to open the computer implemented method and a green border appear showing it is in lockdown mode. The parent then unlocks the user device manually, through his/her own computer implemented method or lets the timer run out.

Lastly, in the present invention if a user is in class and the computer implemented method is in lock down mode, the teacher prompts the user to go to “Lockdown Mode” and the user has to sign in using his/her email/ID (if they have forgotten this, the teacher is enabled to look it up in the class settings). The user is able to change the email linked to the account but cannot change the ID. Once a user logs in, his/her name appears in green with a check mark next to it. If the user tries to open any other application or exit out, his/her name appears in red with an X by it and a sound is emitted to notify the teacher.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates a flow chart of the given invention according to an embodiment of the invention.

### DETAIL DESCRIPTION OF THE INVENTION

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

The present invention relates to a computer implemented method which enables its use on the user smart device and runs on Android/IOS platforms but not limited to these only. The present invention enables at least one user to use the computer implemented method on a smart device and also enables at least one mentor to use the same computer implemented method at the same time, wherein the use of this computer implemented method is for controlling the computer implemented method of the user through the lockdown mode by the mentor. The lockdown mode of the mentor enables him/her to control the computer implemented method of the user and thus lock the smart device of the user to restrain the user from opening any other application, close out of the computer implemented method, or receive any notification during the use of the computer implemented method. Therefore, converting the user's smart device solely into a computer implemented method, wherein during the lockdown mode wherein the user cannot exit out the computer implemented method, cannot call, send text, open other application, receive new notification, open internet, other social media sites, or take pictures and also the user's smart device does not make any noise during the lock down mode.

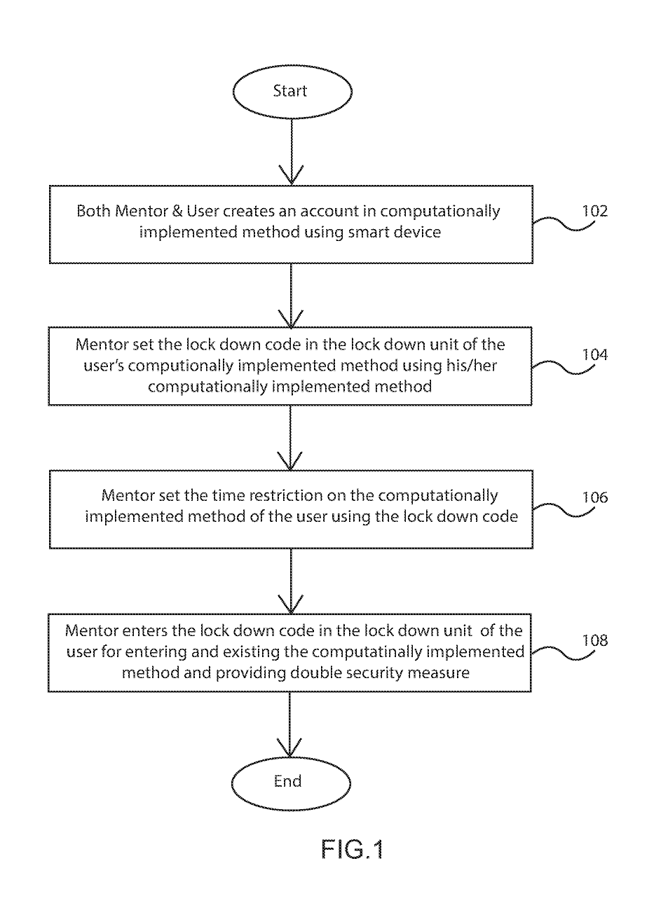

FIG. 1 shows a flow chart of computer implemented method of the instant invention.

STEP 102 of FIG. 1 illustrates creating an account on computer implemented method for both including at least one of the users and for at least one of the mentors, wherein the user includes the student and the mentor includes the teacher, proctor or the parent of at least one user. The teachers, parents, proctors and students get registered on the computer implemented method. A user and a mentor cannot get access to the computer implemented method until he/she is registered. Each login takes the user and the mentor to a specific page customized for each group of and user. The mentor signs up with an email and creates a username and password. A user logs in with an email and this generates a unique ID that is alphanumeric and case sensitive. This helps to associate the right user with their classes, avoid confusion if a user has the same name as another user and also ensures the correct user is registering to take the test with the mentor.

STEP 104 of FIG. 1 illustrates setting a lock down code by using a lock down unit, wherein the lock down unit enables entering the lock down code by at least one mentor to affect at least one user's smart device, wherein when the user's smart device is in lockdown mode, it has a green border around it. If at least one of the user's using the computer implemented method on his/her smart device tries to exit the computer implemented method without the mentor's permission or tries to open a different application during lockdown mode the border turns red and his/her name turns red with an X by it and also a noise is issued from the mentors computer implemented method to alert at least one of the mentors. At least one of the mentors are able to engage the user's smart device in the lock down mode individually or do a mass lockdown for an entire group of users through the computer implemented method. This also enables a mentor to select one of the individualized lockdown codes and it then prompts the user to log in on the device using his/her email/username and password. This prevents friends or those who should not have the ability to lockdown a device from doing so. Only those who are registered as a teacher, proctor or parent have the ability to lockdown a device.

STEP 106 of FIG. 1 illustrates setting a time restriction on the lock down code, wherein the time restriction on the lock down code enables the user's smart device to function as the computer implemented method for the set period of time. In the present invention of the computer implemented method the lock down code provided via lock down unit expires after a period of time allotted by at least one of the mentors on at least one of the users' smart devices. This further enables its use for the class room purposes and for various examination purposes. For example a computer implemented method running on the user's smart device, wherein the mentor themselves sets a lock down code restriction of a time limit for 1 hour and 30 minutes for example, to use during class time or possibly a two hour (or more) restriction limit for exams to be used in class or in a work place or while doing homework at home. The smart device remains in lockdown mode until the time runs out, wherein the smart device automatically returns to its normal functionality. While the user's smart device is in the lock down mode the name of the user is shown in green with a check mark on the mentors computer implemented method and there is a green border around the device on the users screen. If the user attempts to close out of the computer implemented method or open any other application, his/her name turns red with an “X” on the mentors computer implemented method and the border turns red on the user's screen. If the user is not in lock down mode, no border color is displayed around the screen.

STEP 108 of FIG. 1 providing double security measures, wherein the double security enables the entry and exit from the lock down unit by enabling a time restriction on the lock down code. Herein, the entry as well as the exit of at least one of the users from the lock down unit is done either by the mentor entering the lock down code or by the timer reaching the end of its allotted time and releasing all users from lockdown mode. In case of the entry and exit of the user through lock down code, the user opens the computer implemented method on his/her smart device wherein, the user enters the computer implemented method by a lock down code provided by at least one of the mentors and the user is also able to exit the lock down mode by directly entering the lock down code provided by the mentor or the mentor entering the code directly into the user's device. In case of the entry and exit of the user through timer, the mentor is enabled to restrict the use of the computer implemented method via timer wherein, when the timer runs out, the user automatically gets logged out of the computer implemented method. In case of the entry and exit of the user through date, the mentor is enabled to set a date restriction which enables the user to access the computer implemented method till the set date and the lock down code automatically expires after the set date.

In the preferred embodiment of the present invention the method is used by a teacher wherein, the teacher is enabled to register on the computer implemented method, and is also enabled to create a group of students from the class. The teacher provides the group of students a name and a unique code. The students get entered into the group by two ways:
I. the teacher is enabled to send the students a unique code for enabling the lock down mode and have the student text/email it to a general account; or
II. the teacher is enabled to add students manually by entering their email/unique code that is linked with the student's account.
   Once a student is registered into an account, his/her name appears in black on the roster displayed on the computer implemented method of the teacher. The teacher selects the unique ID appearing by the name of the student in the roster (in case they have students with the same name). When the teacher wants to set the group of students into lockdown mode, the teacher first selects the group of students and customizes the computer implemented method if he/she chooses to do so. To customize the computer implemented method, the teacher clicks the link which pulls up all computer implemented method functionalities. The teacher is enabled to “X” out any functions he/she does not want the student to use at that time or within a date and time range. The teacher may choose to share notes, formulas or other aids to the users. The teacher then tells the students to open the computer implemented method on their smart device and select the “lockdown mode”. The student then is prompted to log in and enter their email/ID linked to the account. Once the student has logged in, his/her name now appears in green with a check mark next to it and his/her smart device has a green border on the screen. If a student tries to back out at this point, his/her name goes to red with an X by it and the border turn red. As the students are all logging in, the teacher enter the timer and the lockdown code that they create. Once all students names are in green, the teacher select “enter lockdown code.” When the teacher does this a “start timer” button appears on the student's device. If the student tries to exit or open another application at this point, their name appears in red with an X, the border on his/her smart device turns red, and the website/app make a noise to notify the teacher. If the teacher is controlling it by their own device, the will be alerted by a notification banner. The student also is not able to have access to the computer implemented method until he/she actuates “start timer.”

In other embodiment of the present invention if a student is in class and the computer implemented method is in lock down mode, the teacher prompts the student to go to “Lockdown Mode” and the student has to sign in using his/her email/ID (if they have forgotten this, the teacher is enabled to look it up in the class settings). The student is able to change the email linked to the account but cannot change the ID. Once a student logs in, his/her name appears in green with a check mark next to it and if he/she tries to open any other application or exit out his/her name appear in red with an X by it and notify the teacher.

In another embodiment of the present invention, the parent is enabled to create a login/ID for the user, wherein the user is enabled to login using the email/ID created by his/her parent and the user remains in the parent's account until the parent deletes the user from his/her account. Herein, the user's name shows up in black on the parent's home page. The parent can open the computer implemented method and select “Lockdown Mode” which then prompts the user to login to their account. Once the user has done this, his/her name appears in green with a check mark next to it on the computer implemented method of the parent and the parent is then enabled to enter in a timer with a lockdown code. Once the parent hits “enter lockdown code” the user receives a “start timer” option to open the computer implemented method and a green border appear showing it is in lockdown mode. The parent then unlocks the user device manually, through his/her own computer implemented method or allows the timer to run out.

While the invention has been described in detail with specific reference to preferred embodiments thereof, it is understood that variations and modifications thereof may be made without departing from the true spirit and scope of the invention.

What is claimed is:

1. A computer implemented method comprising the steps of:
providing a main computer device;
wherein said main computer device is adapted to control a plurality of secondary computer devices;
providing a plurality of secondary computer devices;
wherein said a plurality of secondary computer devices are adapted to be controlled by said main computer device;
providing and downloading a computer application upon said main computer device;
wherein said computer application is adapted to allow said main computer device to control each of said plurality of secondary computer devices individually; and
wherein said computer application is adapted to allow said main computer device to initiate a lockdown mode that locks down each of said plurality of secondary computer devices individually, such that a user controlling said main computer device can restrain users of each respective said secondary computer device from opening any other computer application, or receive any notifications during use of said secondary computer device, nor call, send texts, or open internet web sites, or take or send pictures;
providing and downloading a computer application upon each of said secondary computer devices;
wherein said computer application is adapted to allow said main computer device to control each of said plurality of secondary computer devices individually; and
wherein said computer application is adapted to allow said main computer device to initiate a lockdown mode that locks down each of said plurality of secondary computer devices individually, such that a user controlling said main computer device can restrain users of each respective said secondary computer device from opening any other computer application, or receive any notifications during use of said secondary computer device, nor call, send texts, or open internet web sites, or take or send pictures;
wherein said computer application downloaded to said main computer device is further adapted to allow said user of said main computer device to set a time period to which each respective said secondary computer device is in said lockdown mode.

2. The computer implemented method of claim 1, wherein said computer application downloaded to said main computer device is further adapted to create a lockdown exit code for each respective said plurality of secondary computer devices, such that each respective user of each respective one of said plurality of secondary computer devices is able to exit said lockdown mode by entering its respective lockdown exit code into its respective computer application when given thereto by said user of said main computer device.

3. The computer implemented method of claim 1, wherein said computer application downloaded to said main computer device is further adapted to provide a visual overview of a lockdown status of each respective said plurality of secondary computer devices upon a computer screen of said main computer device, such that said user of said main computer device can verify and monitor the lockdown status of each respective said plurality of secondary computer devices.

4. The computer implemented method of claim 3, wherein said visual overview of said lockdown status of each respective said plurality of secondary computer devices includes green and red colored symbols; wherein one of said green colored symbols appears next to the status of each of said plurality of secondary computer devices that are in compliance with said lockdown mode; and wherein one of said red colored symbols appears next to the status of each of said plurality of secondary computer devices that are in violation of said lockdown mode.

5. The computer implemented method of claim 4, wherein said computer application downloaded to said main computer device is further adapted to provide an audio alarm when one of said secondary computer devices are in violation of said lockdown mode.

6. The computer implemented method of claim 2, wherein said computer application downloaded to said main computer device is further adapted to create a time limit for the use of each respective said lockdown exit code.
